(19) United States
(12) Patent Application Publication
(10) Pub. No.: US 2026/0148687 A1
(43) Pub. Date: May 28, 2026

(54) DISPLAY DEVICE AND OPERATING METHOD THEREOF

(71) Applicant: YouB LAB Inc., Seongnam-si (KR)

(72) Inventors: Bong Hyun YOU, Seoul (KR); Je In YOU, Seoul (KR)

(21) Appl. No.: 19/387,552

(22) Filed: Nov. 12, 2025

(30) Foreign Application Priority Data
Nov. 25, 2024 (KR) 10-2024-0169717

(51) Int. Cl. G09G 3/32

(52) U.S. Cl. CPC G09G 3/32; G09G 2300/0452; G09G 2300/0819; G09G 2310/0267; G09G 2310/0286; G09G 2310/08; G09G 2320/0242; G09G 2320/045; G09G 2340/0457

(57) ABSTRACT

Provided is a display device including a pixel having a first sub-pixel and a second sub-pixel configured to emit light of a color different from the first sub-pixel, a first charging control line for providing a first charging control signal, and a second charging control line for providing a second charging control signal, wherein the first sub-pixel includes: a first light-emitting diode, a first driving transistor having one end connected to the first light-emitting diode, and a first charging transistor configured to provide a reference voltage to a gate of the first driving transistor, and wherein the second sub-pixel includes: a second light-emitting diode, a second driving transistor having one end connected to the second light-emitting diode, and a second charging transistor configured to provide the reference voltage to a gate of the second driving transistor in response to the second charging control signal.

### CROSS-REFERENCE TO RELATED APPLICATION

This application is based on and claims the benefit of priority to Korean Patent Application No. 10-2024-0169717, filed Nov. 25, 2024, the aforementioned priority application being hereby incorporated by reference in its entirety.

### TECHNICAL FIELD

The present invention relates to a display device, and more particularly, to a display device and an operating method thereof capable of solving the problem of non-uniform driving characteristics between pixels.

### BACKGROUND

Display technology is continuously evolving to enhance user experience. In particular, display panels are being manufactured in increasingly larger sizes, and pixel density and resolution are steadily increasing to achieve ultra-high-resolution screen quality. While this advancement provides more vivid image quality and immersion, it is accompanied by various technical challenges that must be solved.

Particularly, there is a possibility that the driving characteristics between pixels may not be uniform due to process variations that can occur during the manufacturing process. This can cause a problem where individual pixels do not operate identically according to the required data voltage or current, and such non-uniformity can lead to degradation of display quality.

Therefore, there is a need for a display device that can solve the problem of non-uniform driving characteristics between pixels, which degrades the quality of the display device.

### SUMMARY

An object of the present invention is to provide a display device and an operating method thereof that can improve display quality and color reproducibility by solving the problem of non-uniform driving characteristics between pixels, which can occur during the manufacturing process, thereby enabling each sub-pixel to emit light while maintaining a constant driving current despite process variations.

Another object of the present invention is to provide a display device and an operating method thereof that can effectively improve the problem of non-uniform light emission due to threshold voltage differences, which can particularly occur in blue light-emitting sub-pixels, by independently adjusting the timing and duration of a charging control signal, and through this, can achieve color uniformity of the entire display device and implement a high-resolution screen, thereby providing an enhanced visual experience to the user.

A display device according to an embodiment of the present invention includes: a pixel including a first sub-pixel and a second sub-pixel configured to emit light of a color different from the first sub-pixel; a first charging control line for providing a first charging control signal, which is activated during a first time interval, to the first sub-pixel; and a second charging control line for providing a second charging control signal, which is activated during a second time interval different from the first time interval, to the second sub-pixel, wherein the first sub-pixel includes: a first light-emitting diode; a first driving transistor having one end connected to the first light-emitting diode and configured to provide a driving current to the first light-emitting diode; and a first charging transistor configured to provide a reference voltage to a gate of the first driving transistor in response to the first charging control signal, and wherein the second sub-pixel includes: a second light-emitting diode; a second driving transistor having one end connected to the second light-emitting diode and configured to provide a driving current to the second light-emitting diode; and a second charging transistor configured to provide the reference voltage to a gate of the second driving transistor in response to the second charging control signal.

As an embodiment, the first sub-pixel may be configured to emit red light or green light, and the second sub-pixel may be configured to emit blue light.

As an embodiment, the first sub-pixel may further include: a first initialization transistor configured to provide an initialization voltage to the one end of the first driving transistor in response to an initialization control signal; a first emission control transistor configured to provide a power supply voltage to the other end of the first driving transistor in response to an emission control signal; a first input transistor configured to provide a voltage corresponding to data to the gate of the first driving transistor in response to a data control signal; a first capacitor connected between the gate of the first driving transistor and the one end of the first driving transistor; and a second capacitor connected between the one end of the first driving transistor and the power supply voltage.

As an embodiment, the second sub-pixel may further include: a second initialization transistor configured to provide the initialization voltage to the one end of the second driving transistor in response to the initialization control signal; a second emission control transistor configured to provide the power supply voltage to the other end of the second driving transistor in response to the emission control signal; a second input transistor configured to provide a voltage corresponding to data to the gate of the second driving transistor in response to the data control signal; a third capacitor connected between the gate of the second driving transistor and the one end of the second driving transistor; and a fourth capacitor connected between the one end of the second driving transistor and the power supply voltage, and a size of the second driving transistor may be larger than that of the first driving transistor.

As an embodiment, the display device may further include a gate driver configured to generate the first charging control signal and provide the first charging control signal to the first charging control line, and to generate the second charging control signal and provide the second charging control signal to the second charging control line.

As an embodiment, a time interval of at least one of the first time interval of the first charging control signal and the second time interval of the second charging control signal may be adjusted by the gate driver.

As an embodiment, the gate driver may include: a shift register for generating a charging control signal based on a gate control signal; a first delay circuit for generating the first charging control signal by adjusting an activation interval of the charging control signal; and a second delay circuit for generating the second charging control signal by adjusting the activation interval of the charging control signal.

As an embodiment, the gate driver may receive a first gate control signal generated based on a first clock and a second gate control signal generated based on a second clock having a different duty cycle from the first clock, and the gate driver may include: a first shift register for generating the first charging control signal based on the first gate control signal; and a second shift register for generating the second charging control signal based on the second gate control signal.

A display device according to an embodiment of the present invention includes: a first pixel including a first sub-pixel; a second pixel placed in a different pixel row from the first pixel and including a second sub-pixel; a first charging control line for providing a first charging control signal to the first pixel; and a second charging control line for providing a second charging control signal to the second pixel, wherein the second charging control signal is adjusted to be activated during a time interval different from the first charging control signal when a usage amount of the second pixel exceeds a predetermined value, and wherein the first sub-pixel includes: a first light-emitting diode; a first driving transistor having one end connected to the first light-emitting diode and configured to provide a driving current to the first light-emitting diode; and a first charging transistor configured to provide a reference voltage to a gate of the first driving transistor in response to the first charging control signal, and wherein the second sub-pixel includes: a second light-emitting diode; a second driving transistor having one end connected to the second light-emitting diode and configured to provide a driving current to the second light-emitting diode; and a second charging transistor configured to provide the reference voltage to a gate of the second driving transistor in response to the second charging control signal.

An operating method of a display device according to an embodiment of the present invention includes: providing an initialization control signal to each of a first sub-pixel and a second sub-pixel to provide an initialization voltage to one end of a first light-emitting diode of the first sub-pixel and one end of a second light-emitting diode of the second sub-pixel, respectively; providing a first charging control signal, which is activated during a first time interval, to the first sub-pixel to provide a reference voltage to a gate of a first driving transistor that provides a driving current to the first light-emitting diode during the first time interval; providing a second charging control signal, which is activated during a second time interval longer than the first time interval, to the second sub-pixel to provide the reference voltage to a gate of a second driving transistor that provides a driving current to the second light-emitting diode during the second time interval; providing an emission control signal to each of the first sub-pixel and the second sub-pixel to charge the one end of the first light-emitting diode to a voltage at which the first driving transistor is turned off and to charge the one end of the second light-emitting diode to a voltage at which the second driving transistor is turned off; and providing a data control signal to each of the first sub-pixel and the second sub-pixel to provide a driving current to the first light-emitting diode by the first driving transistor and to provide a driving current to the second light-emitting diode by the second driving transistor, according to data input to each of the first sub-pixel and the second sub-pixel.

A display device and an operating method thereof according to the present invention can improve display quality and color reproducibility by solving the problem of non-uniform driving characteristics between pixels, which can occur during the manufacturing process, thereby enabling each sub-pixel to emit light while maintaining a constant driving current despite process variations.

A display device and an operating method thereof according to the present invention can effectively improve the problem of non-uniform light emission due to threshold voltage differences, which can particularly occur in blue light-emitting sub-pixels, by independently adjusting the timing and duration of a charging control signal, and through this, can achieve color uniformity of the entire display device and implement a high-resolution screen, thereby providing an enhanced visual experience to the user.

### BRIEF DESCRIPTION OF THE DRAWINGS

Embodiments will be more clearly understood from the following detailed description taken in conjunction with the accompanying drawings in which:

FIG. 1 is a diagram illustrating a display device according to an embodiment of the present invention.

FIG. 2 is a circuit diagram illustrating a configuration of a sub-pixel according to an embodiment of the present invention.

FIG. 3 is a timing diagram for explaining an operation of a sub-pixel according to an embodiment of the present invention.

FIG. 4 is a timing diagram for explaining an operation of a sub-pixel according to another embodiment of the present invention.

FIG. 5 is a diagram for explaining a configuration of a display panel including pixels according to an embodiment of the present invention.

FIG. 6 is a diagram for explaining a configuration of a display panel including pixels according to another embodiment of the present invention.

FIG. 7 is a diagram for explaining a configuration of a display device for generating a charging control signal according to an embodiment of the present invention.

FIG. 8 and FIG. 9 are diagrams for explaining a configuration of a display device for generating a charging control signal according to another embodiment of the present invention.

### DETAILED DESCRIPTION

Hereinafter, specific embodiments of the present invention will be described in detail with reference to the accompanying drawings. In this disclosure, detailed descriptions of well-known functions or configurations will be omitted if they are deemed to unnecessarily complicate or obscure the core of the invention.

The advantages, features, and methods of achieving them in the disclosed embodiments will be clearly understood with reference to the accompanying drawings and the embodiments described below.

However, the present invention is not limited to these embodiments and may be implemented in various forms. These embodiments are provided merely as examples to aid in a comprehensive understanding of the invention and do not limit the scope of the invention.

In the accompanying drawings, the same or similar constituent elements are assigned the same reference numerals. Furthermore, when describing embodiments of the present invention, descriptions of the same or similar constituent elements may be omitted to avoid redundant explanations. However, the omission of such descriptions does not intend that the corresponding constituent elements are not included in a specific embodiment.

The terms used in this disclosure were selected as currently commonly used terms, fully reflecting the functions of the invention, but these may vary depending on the perspectives of technicians in the relevant field or the development of new technologies. In addition, in specific cases, there may be terms arbitrarily selected by the applicant, and in such cases, their meanings will be described in detail in the specification. Therefore, the terms in this disclosure should be interpreted based on their meanings and the overall content of the present invention, rather than as simple names.

In this disclosure, expressions in the singular may include the plural meaning unless explicitly limited to the singular. Conversely, expressions in the plural may be interpreted in the singular in context, unless explicitly limited to the plural. Throughout the specification, when a specific part is stated to “include” a certain constituent element, it means that additional constituent elements may be included, rather than excluding other constituent elements.

In this disclosure, the expression “each of a plurality of A” or “a plurality of A each” may refer to each of all elements included in a plurality of A, or may refer to each of some elements of a plurality of A.

In this disclosure, the expression “one or more A” or “at least one A” may mean a set of one or more of A unless clearly expressed otherwise in context.

The expression “configured to ˜” as used in this disclosure may mean “set to ˜”, “having the ability to ˜”, “changed to ˜”, “made to ˜”, “capable of ˜”, etc., depending on the context. This expression is not limited to “specially designed in hardware,” and for example, a processor configured to perform a specific operation may mean a general-purpose processor capable of performing that operation by executing software, or a special-purpose computer structured through programming to perform that specific operation.

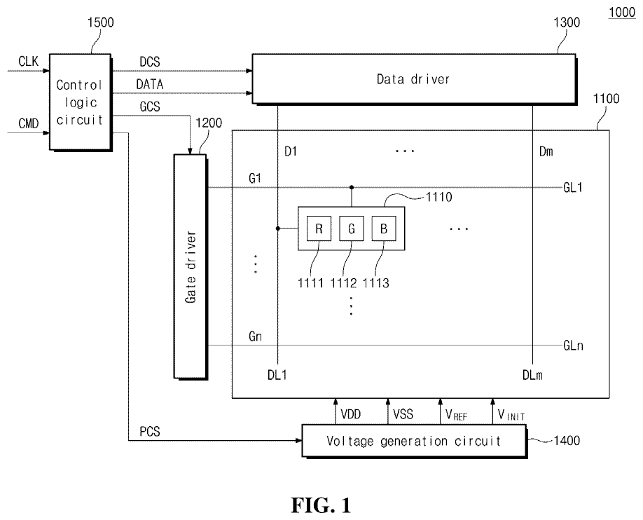

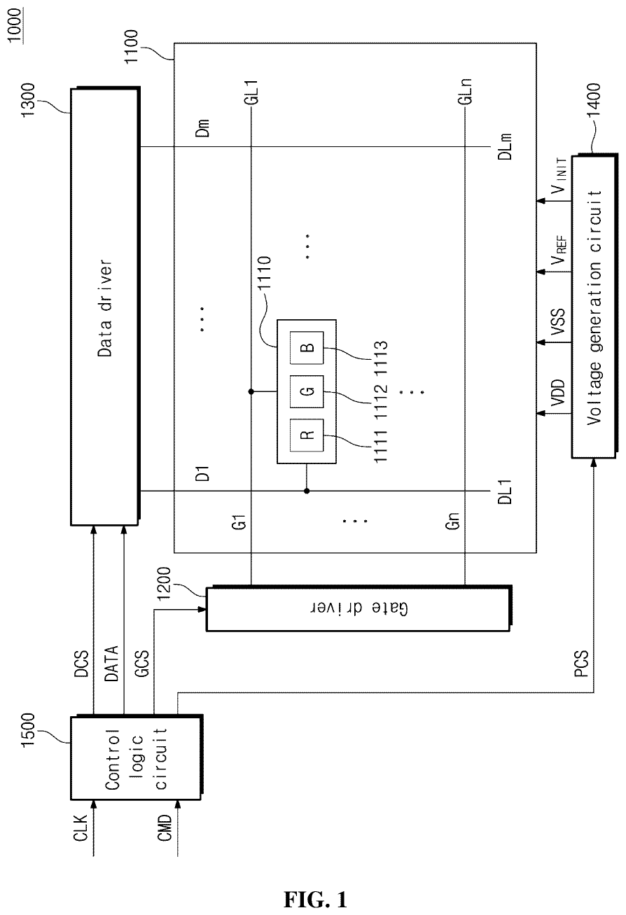

FIG. 1 is a diagram illustrating a display device according to an embodiment of the present invention.

A display device 1000 according to the present invention may include a display panel 1100, a gate driver 1200, a data driver 1300, a voltage generation circuit 1400, and a control logic circuit 1500.

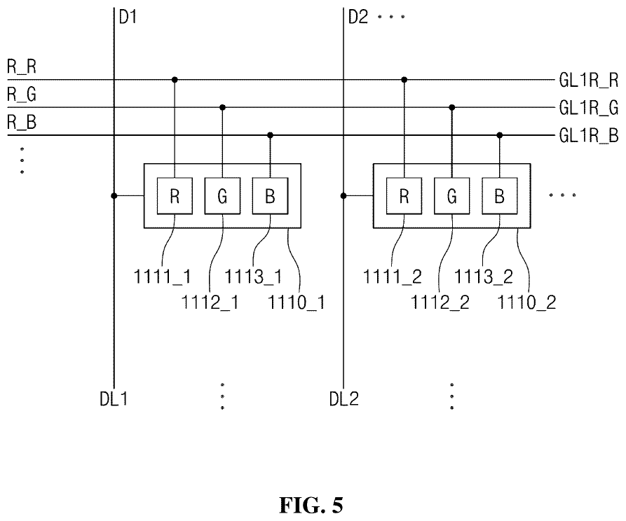

The display panel 1100 may include gate lines (GL1˜GLn) and data lines (DL1˜DLm). Each of the gate lines (GL1˜GLn) may include a plurality of lines (e.g., an initialization control line, a charging control line, a data control line, an emission control line). This will be described in detail with reference to FIG. 5.

The display panel 1100 may include a plurality of pixels connected to the gate lines (GL1˜GLn) and the data lines (DL1˜DLm) (n, m are integers greater than or equal to 1). In FIG. 1, a pixel 1110 located in the first pixel row and the first pixel column among the plurality of pixels is illustratively shown. For example, a pixel (x, y are integers greater than or equal to 1) located in the x-th pixel row and the y-th pixel column may be connected to the x-th gate line (GLx) and the y-th data line (DLy).

The pixel 1110 may include a first sub-pixel 1111, a second sub-pixel 1112, and a third sub-pixel 1113. Each of the first sub-pixel 1111, the second sub-pixel 1112, and the third sub-pixel 1113 may be configured to emit light of a different color. For example, the first sub-pixel 1111 may be configured to emit red light, and the corresponding block is denoted by R. The second sub-pixel 1112 may be configured to emit green light, and the corresponding block is denoted by G. The third sub-pixel 1113 may be configured to emit blue (Blue) light, and the corresponding block is denoted by B.

Each of the first to third sub-pixels (1111˜1113) receives voltages (e.g., ground voltage VSS, power supply voltage VDD, reference voltage VREF, initialization voltage VINIT, etc.) from the voltage generation circuit 1400, and operates according to data provided from the data line DL1 and a plurality of control signals provided by the gate line GL1. Different data may be input to each of the first to third sub-pixels (1111˜1113), and they emit different colors according to the voltage corresponding to each input data, and can express various colors through this color combination. The first to third sub-pixels (1111˜1113) form the colors appearing on the display screen by adjusting brightness and hue according to the RGB combination ratio. Although not shown, the data line DL1 may include three sub-data lines connected to each of the first to third sub-pixels (1111˜1113), the data D1 may include three sub-data, and sub-data corresponding to each of the first to third sub-pixels (1111˜1113) may be input through the three sub-data lines. Since the same applies hereinafter, redundant descriptions will be omitted.

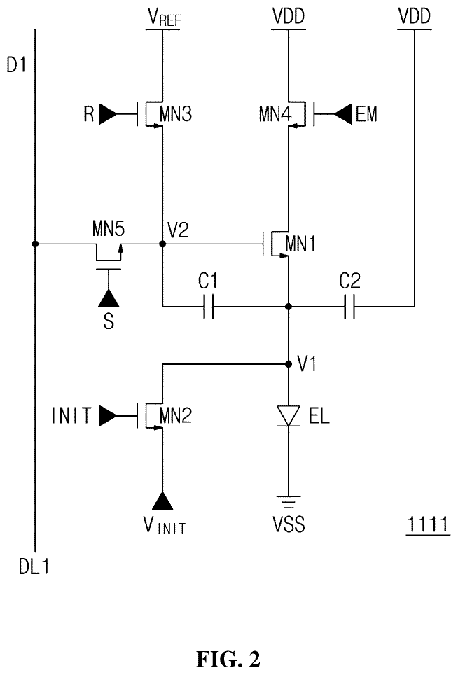

Each of the first to third sub-pixels (1111˜1113) may include a light-emitting diode, a plurality of transistors, and a plurality of capacitors. The configuration of the sub-pixel is described through the circuit diagram of FIG. 2.

The gate driver 1200 receives a gate control signal GCS from the control logic circuit 1500 and provides gate control signals to the gate lines (GL1˜GLn) of the display panel 1100 based on the received gate control signal GCS. The gate control signal GCS may include an initialization control signal, a charging control signal, an emission control signal, a data control signal, etc., and each control signal may be set to a voltage necessary to turn on or turn off each of the plurality of transistors included in the pixel. The gate driver 1200 provides various control signals to the gate lines (GL1˜GLn) so that the transistors of each sub-pixel are activated at the appropriate timing.

In this disclosure, outputting a signal or a signal being activated means that the signal is output at a voltage of a logic that activates the circuit receiving the signal, and not outputting a signal or a signal being deactivated means that the signal is output and maintained at a voltage of a logic that deactivates the circuit receiving the signal. For example, in this disclosure, an activated signal being output to a PMOS transistor means that a logic low-level signal for turning on the PMOS transistor is output, and an activated signal being output to an NMOS transistor means that a logic high-level signal for turning on the NMOS transistor is output.

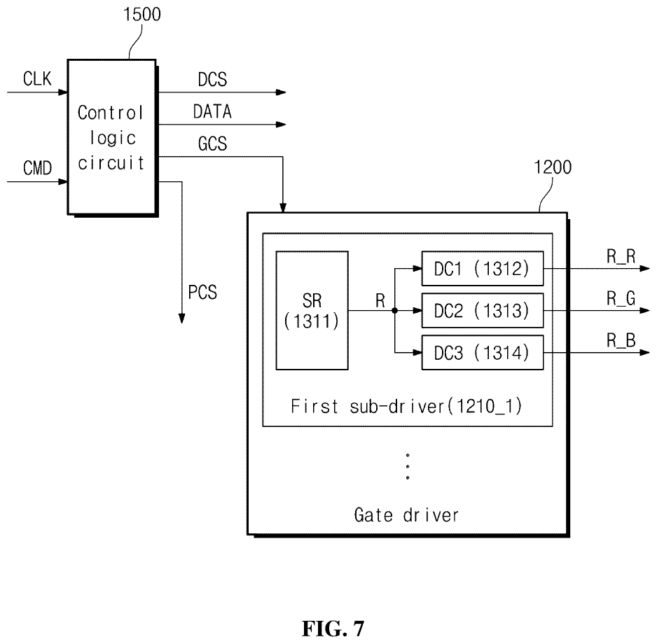

The gate driver 1200 may include a plurality of sub-drivers for providing control signals to each of the gate lines (GL1˜GLn). The structure of the gate driver 1200 according to an embodiment of the present invention will be described in FIG. 7 to FIG. 9.

The data driver 1300 receives a data control signal DCS and image data DATA from the control logic circuit 1500. The data driver 1300 converts the digital format image data DATA into an analog signal and then provides data signals (D1˜Dm) to each of the plurality of pixels through each data line (DL1˜DLm). The data control signal DCS may include a data enable signal, a data clock, a horizontal start signal, etc., that control the output of the data signal.

For example, the data driver 1300 may include a shift register that generates a sampling signal by sequentially shifting a horizontal start signal according to a data clock, a latch that latches the image data DATA according to the sampling signal, a digital-to-analog converter (DAC) that converts the latched image data into an analog data signal, a buffer that outputs the converted data signal to the data lines (DL1˜DLm), etc.

The data driver 1300 receives the image data DATA and provides a voltage corresponding to the data to each sub-pixel so that the sub-pixel can express various colors and brightness levels.

The voltage generation circuit 1400 generates a power supply voltage VDD, a ground voltage VSS, a reference voltage VREF, an initialization voltage VINIT, etc., necessary for driving the plurality of pixels of the display panel 1100 according to a power control signal PCS and provides them to the display panel 1100. However, this is merely an exemplary configuration, and additional power supply voltages may be provided, or some voltages may not be provided, depending on the structure of the sub-pixel.

For example, the power supply voltage VDD is set to a voltage higher than the ground voltage VSS to supply current to the light-emitting diode of the pixel. Here, VSS is expressed as a ground voltage (OV), but this is merely exemplary and is not necessarily limited to a ground voltage of OV, and may be set to any voltage (lower than the power supply voltage VDD) at which the display panel 1100 can operate.

The reference voltage VREF may be a voltage for initializing the gate of each driving transistor included in the first to third sub-pixels (1111˜1113). The reference voltage VREF is a voltage for implementing a predetermined gradation using the voltage difference with the voltage corresponding to the data D1 signal, and may be set to a voltage within the voltage range of the data D1 signal.

The initialization voltage VINIT may be a voltage for initializing each capacitor included in the first to third sub-pixels (1111˜1113). For example, the initialization voltage VINIT may be set to a value lower than the reference voltage VREF, and may also be set to a value lower than the threshold voltage of each light-emitting diode included in the first to third sub-pixels (1111˜1113).

The control logic circuit 1500 can control the overall timing of the display device 1000. The control logic circuit 1500 receives a command CMD, a clock CLK, etc., from an external device (e.g., a computing device, a mobile device, etc.), and generates various control signals (DCS, GCS, PCS) based on the received signals and provides them to the gate driver 1200, the data driver 1300, and the voltage generation circuit 1400. The control logic circuit 1500 may additionally receive input image data from the external device, generate image data DATA based on this, and provide it to the data driver 1300. The control logic circuit 1500 rearranges the image data DATA to match the pixel array in the display panel 1100 and ensures that each pixel receives the desired data at the correct timing to express the correct color.

Although the display device 1000 according to an embodiment of the present invention has been described above with reference to FIG. 1, the display device of the present invention is not limited thereto. Depending on the pixel configuration, signal lines may be added or omitted, and the connection relationship between pixels and signal lines may also be changed. If a specific signal line is omitted, another signal line may replace it.

FIG. 2 is a circuit diagram illustrating a configuration of a sub-pixel according to an embodiment of the present invention.

As described above, the pixel 1110 may include first to third sub-pixels (1111˜1113). In FIG. 2, the structure of a sub-pixel is described using the first sub-pixel 1111 as an example. Each sub-pixel is formed with the same structure, and the type of diode may differ depending on the color of the light emitted. For example, the first sub-pixel 1111 may be configured to emit red light, the second sub-pixel 1112 may be configured to emit green light, and the third sub-pixel 1113 may be configured to emit blue light. In this case, the light-emitting diode of the first sub-pixel 1111 may be a red light-emitting diode, the light-emitting diode of the second sub-pixel 1112 may be a green light-emitting diode, and the light-emitting diode of the third sub-pixel 1113 may be a blue light-emitting diode.

Hereinafter, an MPx transistor (x is a natural number) and an MNy transistor (y is a natural number) mean a PMOS transistor and an NMOS transistor corresponding to the same reference numerals in the drawing, respectively. Furthermore, in this disclosure, although not shown in the drawings, one end of a PMOS transistor in the direction of the power supply voltage VDD is referred to as a source and the other end on the opposite side is expressed as a drain, and one end of an NMOS transistor in the direction of ground is referred to as a source and the other end on the opposite side is expressed as a drain. Furthermore, in this disclosure, for convenience, one end and the other end of a transistor are expressed as a source and a drain, but the source and drain of a transistor are not fixed and the source and drain may be changed according to the applied voltage, and therefore the present invention is not limited by the source and drain of the transistor.

The first sub-pixel 1111 may include an MN1 transistor, an MN2 transistor, an MN3 transistor, an MN4 transistor, an MN5 transistor, a first capacitor C1, a second capacitor C2, and a light-emitting diode EL. The light-emitting diode EL of the first sub-pixel 1111 may be a red light-emitting diode.

In another embodiment, the MN1 to MN5 transistors may each be composed of PMOS transistors, and in this case, the logic of the control signals and data signals may all be reversed.

The source of the MN1 transistor is connected at a node V1 to one end of the first capacitor C1, one end of the second capacitor C2, the drain of the MN2 transistor, and one end of the light-emitting diode EL. The gate of the MN1 transistor is connected at a node V2 to the source of the MN3 transistor, the source of the MN5 transistor, and the other end of the first capacitor C1. The drain of the MN1 transistor is connected to the source of the MN4 transistor. The MN1 transistor is turned on or off according to the gate voltage and can provide a driving current to the light-emitting diode EL. In this disclosure, the MN1 transistor may also be referred to as a driving transistor.

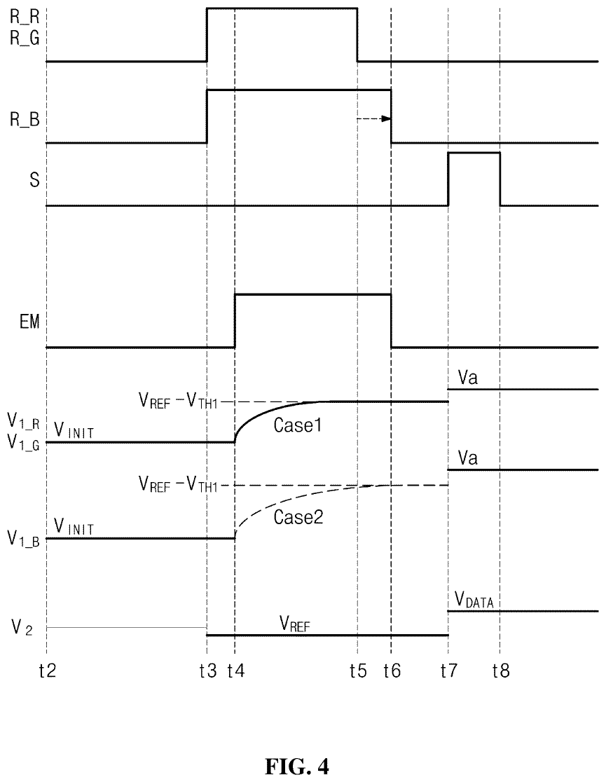

As an embodiment, the size of the driving transistor included in the third sub-pixel 1113 that emits blue light may be larger than each of the driving transistors included in the first and second sub-pixels (1111, 1112) that emit red and green light. This will be described in FIG. 4.

The source of the MN2 transistor is connected to the initialization voltage VINIT, and is turned on or off according to an initialization control signal INIT connected to the gate, thereby providing the initialization voltage VINIT to the node V1 where one end of the MN1 transistor and one end of the light-emitting diode EL are connected. In this disclosure, the MN2 transistor may also be referred to as an initialization transistor.

The drain of the MN3 transistor is connected to the reference voltage VREF, and the source is connected to the node V2. The MN3 transistor is turned on or off according to a charging control signal R connected to the gate, thereby providing the reference voltage VREF to the gate of the MN1 transistor (corresponding to the node V2). In this disclosure, the MN3 transistor may also be referred to as a charging transistor.

The drain of the MN4 transistor is connected to the power supply voltage VDD, and the source is connected to the drain of the MN1 transistor. The MN4 transistor provides the power supply voltage VDD to the drain of the first transistor according to an emission control signal EM. In this disclosure, the MN4 transistor may also be referred to as an emission control transistor.

The drain of the MN5 transistor is connected to the data line (in this embodiment, the first data line DL1), and the source is connected to the node V2. The MN5 transistor provides a voltage corresponding to data D1 to the gate of the MN1 transistor (corresponding to the node V2) according to a data control signal S connected to the gate of the MN5 transistor. In this disclosure, the MN5 transistor may also be referred to as an input transistor.

The first capacitor is connected between the gate of the MN1 transistor (node V2) and the source of the MN1 transistor. The second capacitor C2 is connected between the source of the MN1 transistor and the power supply voltage VDD.

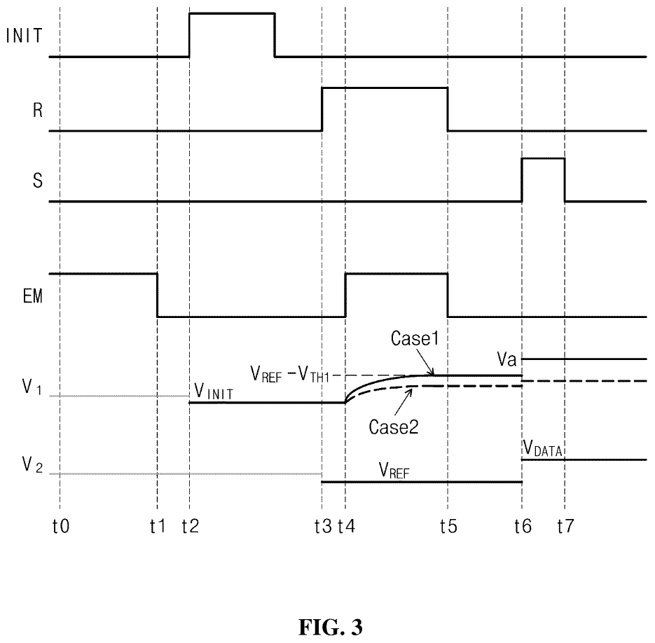

The operation of the sub-pixel will be described with reference to FIG. 3 and FIG. 4.

FIG. 3 is a timing diagram for explaining an operation of a sub-pixel according to an embodiment of the present invention.

In the embodiment of FIG. 3, the first to third sub-pixels (1111˜1113) receive the same initialization control signal INIT, charging control signal R, data control signal S, and emission control signal EM through the same initialization control line, charging control line, data control line, and emission control line, respectively, and emit light from each light-emitting diode according to the received control signals.

The operation results of the first to third sub-pixels (1111˜1113) according to the embodiment of FIG. 3 may be the same from t0 to t4, but the operation results may differ after time t4. This will be described below.

In the interval t0˜t1, the initialization control signal INIT, the charging control signal R, and the data control signal S are deactivated, and the emission control signal EM is activated. Accordingly, a predetermined voltage is applied to the node V1 and the node V2 of each of the first to third sub-pixels (1111˜1113), and the drain of the MN1 transistor is provided with the power supply voltage VDD.

In the interval t1˜t2, the emission control signal EM is also deactivated, and the drain of the MN1 transistor enters a floating state.

In the interval t2˜t3, the activated initialization control signal INIT is provided to the gate of the MN2 transistor of each of the first to third sub-pixels (1111˜1113). Accordingly, the MN2 transistor is turned on, providing the initialization voltage VINIT to one end of the light-emitting diode EL (corresponding to the node V1), and the node V1 maintains the initialization voltage VINIT level. Before time t3, the initialization control signal INIT is deactivated, and since other signals of the sub-pixel do not change, the node V1 can maintain the initialization voltage VINIT level until t3. Here, the initialization voltage VINIT may be a voltage level lower than the threshold voltage of the light-emitting diode EL.

In the interval t3˜t4, the activated charging control signal R is provided to the gate of the MN3 transistor of each of the first to third sub-pixels (1111˜1113). Accordingly, the MN3 transistor is turned on, providing the reference voltage VREF to the gate of the MN1 transistor (corresponding to the node V2), and the node V2 becomes the reference voltage VREF level.

In the interval t4˜t5, the activated emission control signal EM is provided to the gate of the MN4 transistor of each of the first to third sub-pixels (1111˜1113). Accordingly, the MN4 transistor is turned on, providing the power supply voltage VDD to the drain of the MN1 transistor. Since the power supply voltage VDD is provided to the drain while the reference voltage VREF is applied to the gate of the MN1 transistor, the MN1 transistor is turned on. The driving current flowing through the MN1 transistor charges one end of the light-emitting diode EL (corresponding to the node V1).

In the interval t5˜t6, the charging control signal R and the emission control signal EM are deactivated, and the MN4 transistor of each of the first to third sub-pixels (1111˜1113) is turned off.

In the interval t6˜t7, the activated data control signal S is provided to the gate of the MN5 transistor of each of the first to third sub-pixels (1111˜1113). Accordingly, the MN5 transistor is turned on, and a voltage corresponding to the data of each of the first to third sub-pixels (1111˜1113) is provided to the gate of the MN1 transistor of each of the first to third sub-pixels (1111˜1113). A driving current flows to the light-emitting diode EL by the MN1 transistor, and the light-emitting diode EL emits light output corresponding to the data of each of the first to third sub-pixels (1111˜1113). In this interval, as the voltage of the node V2 changes from the reference voltage VREF to the voltage corresponding to data (VDATA), the resulting voltage difference is distributed by the first and second capacitors (C1, C2), and the distributed voltage is added to the voltage of the node V1, so that a predetermined voltage can be formed at the node V1. This will be described below.

In the interval after t7, the light-emitting diode EL of each of the first to third sub-pixels (1111˜1113) maintains the light output according to the data.

In the embodiment of FIG. 3, the result of the operation according to the control signal may vary for each of the first to third sub-pixels (1111˜1113). CASE 1 illustratively shows the operation result of the first sub-pixel 1111 configured to emit red light or the second sub-pixel 1112 configured to emit green light, and CASE 2 illustratively shows the operation result of the third sub-pixel 1113 configured to emit blue light.

In the interval t4˜t5 of CASE 1, the node V1 is charged by the driving current of the MN1 transistor, and its voltage level rises. When the voltage of the node V1 is charged to a predetermined voltage (VREF−VTH1) and the gate-source voltage (VGS) of the MN1 transistor becomes the threshold voltage (VTH1) of the MN1 transistor, the MN1 transistor is turned off. Here, VTH1 is the threshold voltage of the MN1 transistor. As a result, the node V1 can be charged up to the voltage (VREF−VTH1). In this case, in the interval after t6 when data is input, a driving current that is uniform among the sub-pixels can be provided to the light-emitting diode EL, regardless of the difference in the threshold voltage value of the MN1 transistor due to process variations that may occur between sub-pixels. This is explained in detail through Equations 1 to 4 below.

Specifically, when the node V1 is charged to the predetermined voltage (VREF−VTH1) in the interval t4˜t5, the MN1 transistor is turned off, so the voltage of the node V1 maintains the level of VREF−VTH1 even in the interval t5˜t6. At t6, the activated data control signal R is provided to the gate of the MN5 transistor, and as the MN5 transistor is turned on, the voltage corresponding to the data D1 of the data line DL1 is provided to the gate of the MN1 transistor. At this time, the voltage difference (VDATA−VREF) that occurs as the voltage changes from the reference voltage VREF to the voltage corresponding to data VDATA is distributed by the first and second capacitors (C1, C2), and the distributed voltage (C1/(C1+C2)*(VDATA−VREF)) is additionally added to the node V1 which was maintaining the voltage of VREF−VTH1. This is described in Equation 1, and the voltage level of V1 in this interval (corresponding to Equation 1) is denoted as Va in FIG. 3.

$$V 1 = ( V R E F - VTH 1 ) + \frac{C 1}{C 1 + C 2} ( V D A T A - V R E F ) \qquad [ Equation 1 ]$$

Here, if (C1/(C1+C2)*(VDATA−VREF)) is set as A (Equation 2), in the interval t6˜t7, the gate-source voltage of the MN1 transistor becomes VDATA−((VREF−VTH1)+A) since VDATA is applied to the gate of the MN1 transistor (Equation 3).

$$\frac{C 1}{C 1 + C 2} ( VDATA - V R E F ) = A \qquad [ Equation 2 ]$$

$$VGS = V D A T A - V 1 = V D A T A - ( ( V R E F - V T H 1 ) + A ) \qquad [ Equation 3 ]$$

If the drain of the MN1 transistor maintains a sufficient voltage, the MN1 transistor operates in the saturation region in the interval t6˜t7, and the equation for the driving current of the MN1 transistor at this time is as shown in Equation 4 (1). Here, if VGS of Equation 3 is substituted for VGS of the MN1 transistor (Equation 4 (2)), VTH1 is consequently eliminated from the equation for the driving current, so that the driving current is determined by variables independent of VTH1.

$$\begin{matrix}[ Equation 4 ] & \\ I ∝ {K ( VGS - VTH 1 )}^{2} & ( 1 )\end{matrix}$$

$$I ∝ {K ( VDATA - VREF + VTH 1 - A - VTH 1 )}^{2} \qquad ( 2 )$$

$$I ∝ {K ( VDATA - VREF - A )}^{2} \qquad ( 3 )$$

The transistor size or threshold voltage of each sub-pixel may not be identical due to process variations, and in such a case, the amount of driving current of the MN1 transistor of sub-pixels emitting the same color may be different even if the same data voltage is applied. In CASE 1 of the first and second sub-pixels (1111, 1112), which are red and green light-emitting sub-pixels, the node V1 is charged to the predetermined voltage (VREF−VTH1) during the interval t4˜t5, so each MN1 transistor of the sub-pixels can provide a constant driving current to the light-emitting diode EL regardless of the threshold voltage value difference.

However, in the case of the third sub-pixel 1113, which is a blue light-emitting sub-pixel, the node V1 may not be charged up to the predetermined voltage (VREF−VTH1), causing another problem. Typically, blue light-emitting diodes have lower light efficiency compared to red light-emitting diodes or green light-emitting diodes. Therefore, the driving current amount of the blue light-emitting diode needs to be larger, so the MN1 transistor included in the third sub-pixel 1113 that emits blue light must have a larger size compared to the MN1 transistors included in the first and second sub-pixels (1111, 1112) that emit red and green light. However, if the size of the MN1 transistor increases, the parasitic capacitance of the MN1 transistor increases. Parasitic capacitance is unnecessary electrical capacitance that occurs due to the physical arrangement between conductors or components in a circuit, and it naturally increases as the transistor size increases. Due to this, the voltage of the node V1 may not be sufficiently charged up to the predetermined voltage (VREF−VTH1) during the interval t4˜t5. This operation of the third sub-pixel 1113, which is a blue light-emitting sub-pixel, is described in detail in Case 2.

In the case of CASE 2, in the interval t4˜t5, the node V1 is not charged up to the predetermined voltage (VREF−VTH1) due to the parasitic capacitance of the MN1 transistor of the third sub-pixel 1113, and the charging control signal R and the emission control signal EM are deactivated at t5 while the MN1 transistor is not turned off. In t5˜t6, even if the voltage of the node V1 rises, the node V2, which is in a floating state, is coupled to the node V1, so the voltage of the node V2 also rises together, and the MN1 transistor still maintains the turned-on state. Consequently, the operation of the MN1 transistor in t5˜t6 becomes different from CASE 1, and therefore, the voltages of node V1 and node V2 at time to become different from the voltage of node V1 (Va) and the voltage of node V2 (VREF) in the case of CASE 1. Therefore, unlike CASE 1, the effect of VTH1 being eliminated from the driving current of the MN1 transistor according to Equations 1 to 4 disappears, so the light emission intensity for the same data may vary due to the threshold voltage difference of each blue light-emitting sub-pixel.

FIG. 4 is a timing diagram for explaining an operation of a sub-pixel according to another embodiment of the present invention.

The interval t0˜t2 of FIG. 4 is the same as the interval t0˜t2 of FIG. 3, so that interval is omitted, and the waveform of the initialization control signal INIT is also omitted in FIG. 4. Furthermore, in FIG. 4, the operation in the interval t2˜t3 is the same as the operation in the interval t2˜t3 of FIG. 3, so a description thereof will be omitted.

The embodiment of FIG. 4 includes a configuration in which the charging control signal R is separated into a first charging control signal R_R, a second charging control signal R_G, and a third charging control signal R_B in order to solve the problem in the embodiment of FIG. 3 where the voltage of the node V1 of the third sub-pixel 1113 cannot be charged up to the predetermined voltage (VREF−VTH1) during the interval t4˜t5. The first charging control signal R_R is provided to the first sub-pixel 1111, the second charging control signal R_G is provided to the second sub-pixel 1112, and the third charging control signal R_B is provided to the third sub-pixel 1113, respectively.

In the interval t3˜t4, the activated first charging control signal R_R is provided to the gate of the MN3 transistor (first charging transistor) of the first sub-pixel 1111, the activated second charging control signal R_G is provided to the gate of the MN3 transistor (second charging transistor) of the second sub-pixel 1112, and the activated third charging control signal R_B is provided to the gate of the MN3 transistor (third charging transistor) of the third sub-pixel 1113. The reference voltage VREF is provided to the gate (corresponding to node V2) of the MN1 transistor (first to third driving transistors) of each of the first to third sub-pixels (1111˜1113) through the MN3 transistor (first to third charging transistors) of each of the first to third sub-pixels (1111˜1113).

In the interval t4˜t5, the activated emission control signal EM is provided to the gate of the MN4 transistor of each of the first to third sub-pixels (1111˜1113), and the MN1 transistor (first to third driving transistors) of each of the first to third sub-pixels (1111˜1113) is turned on, so that one end (node V1) of each light-emitting diode EL begins to be charged by the driving current. The nodes (V1_R, V1_G) of the first and second sub-pixels (1111, 1112) are charged up to the predetermined voltage (VREF−VTH1) in the interval t4˜t5, as in the example of FIG. 3. However, as described in FIG. 3, the node V1_B of the third sub-pixel 1113 is still not charged up to the predetermined voltage (VREF−VTH1) due to the parasitic capacitance of the MN1 transistor (third driving transistor) of the third sub-pixel 1113.

In the interval t5˜t6, the first charging control signal R_R and the second charging control signal R_G are deactivated, and the third charging control signal maintains the activated state until time t6. Therefore, the third sub-pixel 1113 can be charged up to the predetermined voltage (VREF−VTH1) at the node V1_B by the activated third charging control signal R_B and emission control signal EM until time t6.

Here, although the first charging control signal R_R and the second charging control signal R_G are shown as being activated during the interval t3˜t5, this is merely exemplary, and the activation intervals of the first charging control signal R_R and the second charging control signal R_G may be different.

In the interval t6˜t7, the emission control signal EM is deactivated, and the MN4 transistor (first to third emission control transistors) of each of the first to third sub-pixels (1111˜1113) is turned off.

In the interval t7˜t8, the activated data control signal S is provided to the gate of the MN5 transistor (first to third input transistors) of each of the first to third sub-pixels (1111˜1113), and the voltage corresponding to each data is provided to the gate of each of the first to third driving transistors (MN1 transistors). According to each input data, a driving current is provided by the first to third driving transistors (MN1 transistors) to the light-emitting diode EL of each of the first to third sub-pixels (1111˜1113), and the light-emitting diode EL emits light output corresponding to each data.

As described above, the embodiment of FIG. 4 separates the charging control signal into the first charging control signal R_R, the second charging control signal R_G, and the third charging control signal R_B, and extends the duration of the third charging control signal R_B, thereby enabling the node V1_B of the third sub-pixel 1113 that emits blue light to be charged up to the predetermined voltage (VREF−VTH1) in the interval t4˜t6. Accordingly, in the interval t7˜18, the node V1_B of the third sub-pixel 1113 reaches the voltage level of Equation 1 (corresponding to Va in FIGS. 3 and 4), so that, as described in Equations 1 to 4, VTH1 is eliminated from the driving current equation, and the driving current is determined by variables independent of VTH1. Therefore, the third sub-pixel 1113 according to the embodiment of FIG. 4 can secure uniformity of the driving current, similar to the first and second sub-pixels (1111, 1112).

Therefore, the embodiment of FIG. 4 solves the problem of non-uniform light emission due to threshold voltage differences that can occur in blue light-emitting sub-pixels, and contributes to improving the color reproducibility of the entire display.

As an embodiment, the duration of the charging control signal can be adjusted based on the usage amount of the pixel with the maximum usage among the plurality of pixels in the pixel row. Whereas adjusting the duration of the charging control signal of the blue light-emitting sub-pixel is to compensate for initial characteristics, this embodiment is an embodiment that compensates for the change in the characteristics of the pixel's transistors due to accumulated stress from the use of the display device 1000. For example, the display device 1000 may track and store the usage amount of each of the plurality of pixels included in the display panel 1100. The display device 1000 may adjust the duration of the charging control signal of the corresponding pixel row by considering the highest usage amount among the usage amounts of the pixels in each pixel row. For example, if the usage amount of a specific pixel among a specific pixel row exceeds a predetermined threshold value (i.e., the usage amount of the specific pixel row, or the usage amount of the specific pixel in the specific pixel row is relatively high compared to other pixels), the characteristics of the elements including the transistors of that pixel are likely to deteriorate, so to compensate for this, the duration of the charging control signal provided to that pixel row may be adjusted to be longer than the existing duration. This adjustment may be performed by the control logic circuit 1500 and the gate driver 1200, and the adjustment method will be described below.

For example, the display device 1000 for the above embodiment may include: a first pixel including a first sub-pixel; a second pixel placed in a different pixel row from the first pixel and including a second sub-pixel, a first charging control line for providing a first charging control signal to the first pixel, and a second charging control line for providing a second charging control signal to the second pixel. Here, the second charging control signal may be adjusted to be activated during a time interval different from the first charging control signal when a usage amount of the second pixel exceeds a predetermined value. The predetermined value may be a value set initially, or the predetermined value may change to increase according to the usage amount of the display device 1000.

FIG. 5 is a diagram for explaining a configuration of a display panel including pixels according to an embodiment of the present invention.

The display device according to the embodiment of FIG. 4 may separate the charging control signal into a first charging control signal R_R, a second charging control signal R_G, and a third charging control signal R_B and provide them to each of the first to third sub-pixels (1111˜1113). To this end, the charging control lines must also be separated. FIG. 5 shows an embodiment of the display panel 1100 in which the charging control lines are separated.

The pixels (1110_1, 1110_2) according to the embodiment of FIG. 5 can receive the first to third charging control signals (R_R, R_G, R_B) through the first to third charging control lines (GL1R_R, GL1R_G, GL1R_B), respectively.

For example, the display panel 1100 may include a first charging control line GL1R_R for providing a first charging control signal R_R, which is activated during a first time interval, to each of the first sub-pixels (1111_1, 1111_2), a second charging control line GL1R_G for providing a second charging control signal R_G, which is activated during a second time interval, to each of the second sub-pixels (1112_1, 1112_2), and a third charging control line GL1R_B for providing a third charging control signal R_B, which is activated during a third time interval, to each of the third sub-pixels (1113_1, 1113_2).

As an embodiment, the first time interval may be the same as or different from the second time interval. The third charging control signal R_B may be activated during a third time interval that is longer than the first time interval and the second time interval.

The first data line DL1 is connected to the first pixel 1110_1 to provide corresponding data D1, and the second data line DL2 is connected to the second pixel 1110_2 to provide corresponding data D2.

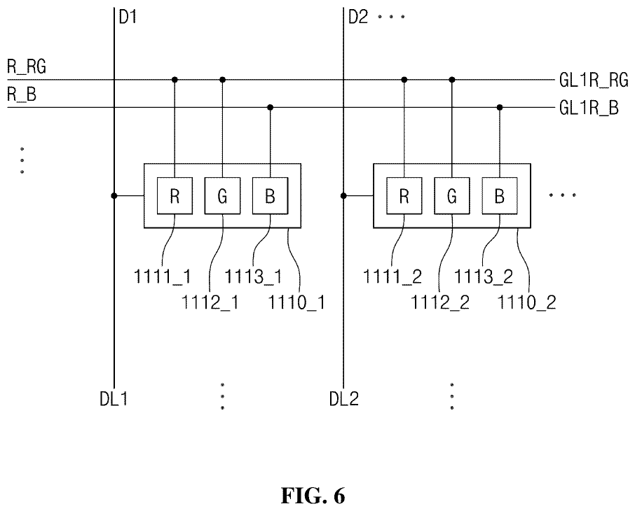

FIG. 6 is a diagram for explaining a configuration of a display panel including pixels according to another embodiment of the present invention.

Unlike the embodiment of FIG. 5, the display panel 1100 according to the embodiment of FIG. 6 includes two charging control lines, not three, i.e., first and second charging control lines (GL1R_RG, GL1R_B), thereby solving the driving current non-uniformity problem of the blue light-emitting sub-pixel with a simplified configuration.

The pixels (1110_1, 1110_2) according to the embodiment of FIG. 6 receive a first charging control signal R_RG through the first charging control line GL1_RG and receive a second charging control signal R_B through the second charging control line GL1_B, respectively.

For example, the first sub-pixels (1111_1, 1111_2) and the second sub-pixels (1112_1, 1112_2) that emit green light may receive a charging control signal R_RG, which is activated during a first time interval, through one charging control line GL1R_RG, and the third sub-pixels (1113_1, 1113_2) that emit blue light may receive a charging control signal R_B, which is activated during a second time interval, through another charging control line GL1R_B.

As an embodiment, the charging control signal R_B may be activated during a second time interval that is longer than the first time interval.

The first data line DL1 is connected to the first pixel 1110_1 to provide corresponding data D1, and the second data line DL2 is connected to the second pixel 1110_2 to provide corresponding data (D2).

FIG. 7 is a diagram for explaining a configuration of a display device for generating a charging control signal according to an embodiment of the present invention.

The first to third charging control signals (R_R, R_G, R_B) described in FIG. 4 and FIG. 5 may be generated and provided by the control logic circuit 1500 and the gate driver 1200. The gate driver 1200 may generate the first charging control signal R_R and provide it to the first charging control line GL1R_R, generate the second charging control signal R_G and provide it to the second charging control line GL1R_G, and generate the third charging control signal R_B and provide it to the third charging control line GL1R_B. The gate driver 1200 may adjust a time interval of at least one of the first time interval of the first charging control signal R_R, the second time interval of the second charging control signal R_G, and the third time interval of the third charging control signal R_B.

In the display device of the embodiment of FIG. 7, the data driver 1300, the voltage generation circuit 1400, and the control logic circuit 1500 are as described in FIG. 1, and the structure and operation of the display panel 1100 are also as described in FIG. 1, FIG. 2, and FIG. 4 to FIG. 6, so descriptions thereof will be omitted, and hereinafter, the description will focus on the configuration and operation of the gate driver 1200.

The gate driver 1200 may include a plurality of sub-drivers. For example, the gate driver 1200 may include a first sub-driver 1210_1, and the first sub-driver 1210_1 may include a shift register 1311, a first delay circuit 1312, a second delay circuit 1313, and a third delay circuit 1314.

The shift register 1311 generates a charging control signal R based on the gate control signal GCS provided from the control logic circuit 1500. The charging control signal R is provided to the first to third delay circuits (1312˜1314). Although not shown, the shift register 1311 may additionally generate an initialization control signal INIT, an emission control signal EM, and a data control signal S and sequentially provide them to the gate line of the corresponding row (e.g., the first gate line GL1). As described above, each of the gate lines may include a plurality of lines (e.g., an initialization control line, a data control line, an emission control line). The first to third charging control lines may also be included in the gate line of the corresponding row.

The first delay circuit 1312 may generate the first charging control signal R_R by adjusting the activation interval of the charging control signal R provided from the shift register 1311, the second delay circuit 1313 may generate the second charging control signal R_G by adjusting the activation interval of the charging control signal R provided from the shift register 1311, and the third delay circuit 1314 may generate the third charging control signal R_B by adjusting the activation interval of the charging control signal R provided from the shift register 1311. Each of the first to third delay circuits (1312˜1314) can independently adjust the duration of the charging control signal R and change the activation interval of the charging control signal to compensate for the charging delay problem of the node V1_B that may occur in a specific sub-pixel (e.g., the blue sub-pixel 1113).

The structure of the first to third delay circuits (1312˜1314) can adjust the activation interval of the signal through methods such as delaying only a specific edge (e.g., falling edge) of the charging control signal R. However, the structure of the delay circuit may be configured in various forms to adjust the activation interval of the charging control signal R, and the present invention is not limited thereto.

The gate driver 1200 provides the generated first charging control signal R_R, second charging control signal R_G, and third charging control signal R_B to the first charging control line GL1R_R, the second charging control line GL1R_G, and the third charging control line GL1R_B, respectively. Through this, each sub-pixel of the display panel 1100 receives each charging control signal at a predetermined timing and can operate stably.

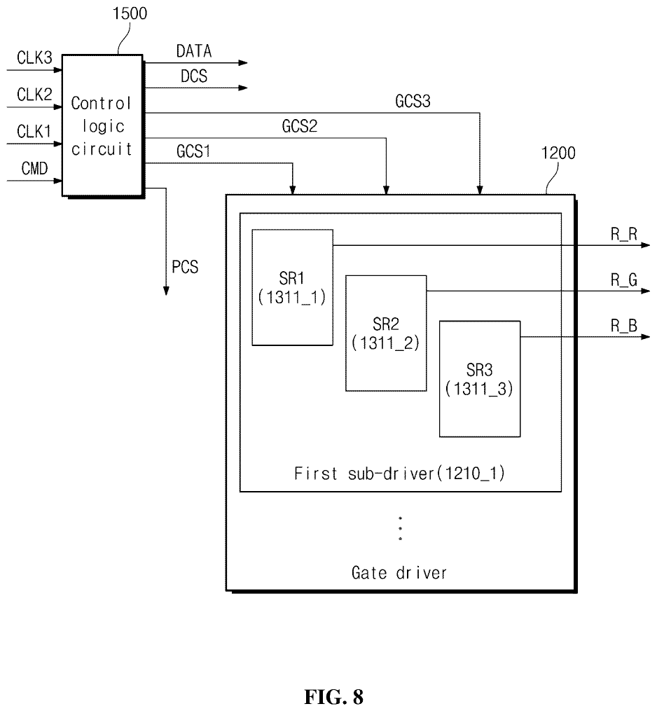

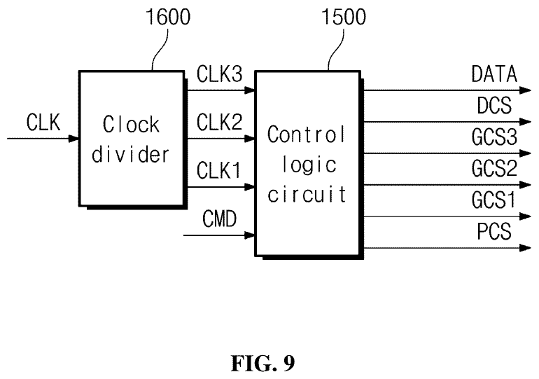

FIG. 8 and FIG. 9 are diagrams for explaining a configuration of a display device for generating a charging control signal according to another embodiment of the present invention.

In the embodiments of FIGS. 8 and 9, the data driver 1300 and the voltage generation circuit 1400 are as described in FIG. 1, and the structure and operation of the display panel 1100 are also as described in FIG. 1, FIG. 2, and FIG. 4 to FIG. 6, so descriptions thereof will be omitted, and hereinafter, the description will focus on the configuration and operation of the gate driver 1200 and the control logic circuit 1500.

Compared to the embodiment of FIG. 7, the first sub-driver 1210_1 according to the embodiment of FIG. 8 does not include delay circuits, but may include first to third shift registers (1311_1˜1311_3) for generating the first to third charging control signals (R_R, R_G, R_B).

The gate driver 1200 may receive a first gate control signal GCS1 generated based on a first clock CLK1, a second gate control signal GCS2 generated based on a second clock CLK2, and a third gate control signal GCS3 generated based on a third clock CLK3.

As an embodiment, the third clock CLK3 may have a different duty cycle from at least one of the first clock CLK1 and the second clock CLK2. Each of the first to third clocks (CLK1˜CLK3) may be provided from an external device (e.g., a computing device, a mobile device, etc.).

The gate driver 1200 may include a plurality of sub-drivers. For example, the gate driver 1200 includes a first sub-driver 1210_1, and the first sub-driver 1210_1 may include a first shift register 1311_1, a second shift register 1311_2, and a third shift register 1311_3.

The first shift register 1311_1 may generate the first charging control signal R_R, which is activated during a first time interval, based on the first gate control signal GCS1, the second shift register 1311_2 may generate the second charging control signal R_G, which is activated during a second time interval, based on the second gate control signal GCS2, and the third shift register 1311_3 may generate the third charging control signal R_B, which is activated during a third time interval, based on the third gate control signal GCS3. The generated first to third charging control signals (R_R, R_G, R_B) are each provided to the corresponding charging control lines (GL1R_R, GL1R_G, GL1R_B).

The first time interval, the second time interval, and the third time interval may each be determined according to the duty cycle of each of the first clock CLK1, the second clock CLK2, and the third clock CLK3. That is, each of the first to third clocks (CLK1˜CLK3) may have a duty cycle corresponding to the activation interval of the first to third charging control signals (R_R, R_G, R_B), the first to third gate control signals (GCS1˜GCS3) may be determined based on the first to third clocks (CLK1˜CLK3), and the activation intervals of the first to third charging control signals (R_R, R_G, R_B) may be determined based on the activation intervals of the first to third gate control signals (GCS1˜GCS3). As described above, the first to third time intervals may be determined according to the embodiments of FIG. 4 to FIG. 6.

The control logic circuit 1500 generates the first to third gate control signals (GCS1, GCS2, GCS3) based on the command CMD and clocks (CLK1, CLK2, CLK3) input from the outside. Here, the input clocks (CLK1˜CLK3) may each have a different duty cycle, and the timing and characteristics of the gate control signals (GCS1˜GCS3) may be adjusted by the duty cycle of the clocks (CLK1˜CLK3).

The display device 1000 according to the embodiment of FIG. 9 may further include a clock divider 1600 compared to the embodiment of FIG. 8. Unlike the embodiment of FIG. 8, the display device 1000 of FIG. 9 receives only one clock CLK from an external device, and the clock divider 1600 may divide the corresponding clock CLK into first to third clocks (CLK1˜CLK3) and provide them to the control logic circuit 1500. The control logic circuit 1500 may generate the first to third gate control signals (GCS1˜GCS3) based on the input first to third clocks (CLK1˜CLK3). The operations of the control logic circuit 1500 and the gate driver 1200 are as described in the embodiment of FIG. 8, so descriptions thereof will be omitted.

FIG. 7 to FIG. 9 illustrate the gate driver and control logic circuit of the display device according to various embodiments of the present invention, and show exemplary configurations for generating the first to third charging control signals (R_R, R_G, R_B). However, the display device for generating the first to third charging control signals (R_R, R_G, R_B) may be configured in various ways, and the present invention is not limited thereto.

Although embodiments for generating three control signals, the first to third charging control signals (R_R, R_G, R_B), are shown in FIG. 7 to FIG. 9, if only two charging control signals are needed as in FIG. 6, the configuration may be changed accordingly. For example, a configuration is possible where the same charging control signal R_RG is provided to the first and second sub-pixels (1111, 1112) that emit red and green light, and a separate charging control signal R_B is provided to the third sub-pixel 1113 that emits blue light. In this case, the gate driver 1200 is designed to generate only two charging control signals (first and second charging control signals), and the charging control lines can also be simplified to a first charging control line GL1R_RG and a second charging control line GL1R_B.

To implement this, the first sub-driver 1210_1 of the gate driver 1200 in FIG. 7 may be configured to include one shift register and two delay circuits. Furthermore, in the embodiments of FIG. 8 and FIG. 9, only the first clock CLK1 and the second clock CLK2 may be used, and the charging control signal R_RG activated according to the first clock CLK1 provides the reference voltage VREF to the gates of the driving transistors (MN1 transistors) of the red and green light-emitting sub-pixels, and the charging control signal R_B activated according to the second clock CLK2 may provide the reference voltage VREF to the gates of the driving transistors (MN1 transistors) of the blue light-emitting sub-pixels. This simplified configuration simplifies the overall circuit while allowing the timing and duration of the charging control signals to be adjusted to meet the requirements of each sub-pixel.

The methods according to the present invention may be computer-implemented methods. In this disclosure, although each operation of the methods has been shown and described in a certain order, each operation may be performed in an order that can be arbitrarily combined according to this disclosure, in addition to being performed sequentially. In one embodiment, at least some of the operations may be performed in parallel, iteratively, or heuristically. This disclosure does not exclude changes or modifications to the methods. In one embodiment, at least some operations may be omitted, or other operations may be added.

The various embodiments of the present invention may be implemented as software recorded on a machine-readable recording medium. The software may be software for implementing the various embodiments of the disclosure described above. The software may be inferred from the various embodiments of this disclosure by programmers in the technical field to which this disclosure belongs. For example, the software may be machine-readable instructions (e.g., code or code segments) or a program. A machine is a device capable of operating according to instructions called from a recording medium, and may be, for example, a computer. In one embodiment, the machine may be an electronic device according to the embodiments of this disclosure. In one embodiment, a processor of the machine may execute the called instructions, causing the components of the machine to perform the functions corresponding to the instructions. In one embodiment, the processor may be a processor of an electronic device according to the embodiments of this disclosure. The recording medium may mean any kind of recording medium in which data is stored, which can be read by a machine. The recording medium may include, for example, ROM, RAM, CD-ROM, magnetic tape, floppy disk, optical data storage device, etc. In one embodiment, the recording medium may be a memory. In one embodiment, the recording medium may also be implemented in a distributed form, such as in a computer system connected via a network. The software may be stored and executed in a distributed manner in a computer system or the like. The recording medium may be a non-transitory computer-readable recording medium. A non-transitory computer-readable recording medium means a tangible medium, regardless of whether data is stored semi-permanently or temporarily, and does not include a transitory signal.

As described above, those skilled in the technical field of the present invention will recognize that the present invention can be implemented in various forms without changing its technical principles or core features. Therefore, it should be understood that the above embodiments are illustrative and not limiting the scope of the present invention. The scope of the present invention is defined by the claims below rather than the detailed description, and all variations or modifications according to the meaning and scope of the claims and their equivalent concepts should be interpreted as being included in the scope of the present invention.

The features and advantages described in this disclosure are only some, and more additional features and advantages will be clear to those skilled in the art with reference to the drawings, specification, and claims. Furthermore, it should be noted that the language used in this disclosure was selected for readability and description, and not necessarily selected for the purpose of limiting or describing the subject matter of the present invention.

The descriptions of the above embodiments are presented for illustrative purposes, and are not intended to limit the scope of the present invention to the precise forms. Those skilled in the art will be able to understand that various modifications and variations are possible through the disclosure of the present invention.

Therefore, the scope of the present invention is not limited by the detailed description, but is defined by the claims of this specification. Accordingly, the embodiments of the present invention are illustrative, and do not limit the scope of the present invention described in the claims below.

What is claimed is:

1. A display device, comprising:
a pixel including a first sub-pixel and a second sub-pixel configured to emit light of a color different from the first sub-pixel;
a first charging control line for providing a first charging control signal, which is activated during a first time interval, to the first sub-pixel; and
a second charging control line for providing a second charging control signal, which is activated during a second time interval different from the first time interval, to the second sub-pixel,
wherein the first sub-pixel includes:
a first light-emitting diode;
a first driving transistor having one end connected to the first light-emitting diode and configured to provide a driving current to the first light-emitting diode; and
a first charging transistor configured to provide a reference voltage to a gate of the first driving transistor in response to the first charging control signal, and
wherein the second sub-pixel includes:
a second light-emitting diode;
a second driving transistor having one end connected to the second light-emitting diode and configured to provide a driving current to the second light-emitting diode; and
a second charging transistor configured to provide the reference voltage to a gate of the second driving transistor in response to the second charging control signal.

2. The display device of claim 1, wherein the first sub-pixel is configured to emit red light or green light, and the second sub-pixel is configured to emit blue light.

3. The display device of claim 1, wherein the first sub-pixel further includes:
a first initialization transistor configured to provide an initialization voltage to the one end of the first driving transistor in response to an initialization control signal;
a first emission control transistor configured to provide a power supply voltage to the other end of the first driving transistor in response to an emission control signal;
a first input transistor configured to provide a voltage corresponding to data to the gate of the first driving transistor in response to a data control signal;
a first capacitor connected between the gate of the first driving transistor and the one end of the first driving transistor; and
a second capacitor connected between the one end of the first driving transistor and the power supply voltage.

4. The display device of claim 3, wherein the second sub-pixel further includes:
a second initialization transistor configured to provide the initialization voltage to the one end of the second driving transistor in response to the initialization control signal;
a second emission control transistor configured to provide the power supply voltage to the other end of the second driving transistor in response to the emission control signal;
a second input transistor configured to provide a voltage corresponding to data to the gate of the second driving transistor in response to the data control signal;
a third capacitor connected between the gate of the second driving transistor and the one end of the second driving transistor; and
a fourth capacitor connected between the one end of the second driving transistor and the power supply voltage,
wherein a size of the second driving transistor is larger than that of the first driving transistor.

5. The display device of claim 1, further comprising: a gate driver configured to generate the first charging control signal and provide the first charging control signal to the first charging control line, and to generate the second charging control signal and provide the second charging control signal to the second charging control line.

6. The display device of claim 5, wherein at least one time interval of a first time interval of the first charging control signal and a second time interval of the second charging control signal is adjusted by the gate driver.

7. The display device of claim 5, wherein the gate driver includes:
a shift register for generating a charging control signal based on a gate control signal;
a first delay circuit for generating the first charging control signal by adjusting an activation interval of the charging control signal; and
a second delay circuit for generating the second charging control signal by adjusting the activation interval of the charging control signal.

8. The display device of claim 5, wherein the gate driver receives a first gate control signal generated based on a first clock and a second gate control signal generated based on a second clock having a different duty cycle from the first clock, and
wherein the gate driver includes:
a first shift register for generating the first charging control signal based on the first gate control signal; and
a second shift register for generating the second charging control signal based on the second gate control signal.

9. A display device, comprising:
a first pixel including a first sub-pixel;
a second pixel placed in a different pixel row from the first pixel and including a second sub-pixel;
a first charging control line for providing a first charging control signal to the first pixel; and
a second charging control line for providing a second charging control signal to the second pixel,
wherein the second charging control signal is adjusted to be activated during a time interval different from the first charging control signal when a usage amount of the second pixel exceeds a predetermined value,
wherein the first sub-pixel includes:
a first light-emitting diode;
a first driving transistor having one end connected to the first light-emitting diode and configured to provide a driving current to the first light-emitting diode; and
a first charging transistor configured to provide a reference voltage to a gate of the first driving transistor in response to the first charging control signal, and
wherein the second sub-pixel includes:
a second light-emitting diode;
a second driving transistor having one end connected to the second light-emitting diode and configured to provide a driving current to the second light-emitting diode; and
a second charging transistor configured to provide the reference voltage to a gate of the second driving transistor in response to the second charging control signal.

10. An operating method of a display device, the method comprising:
providing an initialization control signal to each of a first sub-pixel and a second sub-pixel to provide an initialization voltage to one end of a first light-emitting diode of the first sub-pixel and one end of a second light-emitting diode of the second sub-pixel, respectively;
providing a first charging control signal, which is activated during a first time interval, to the first sub-pixel to provide a reference voltage to a gate of a first driving transistor that provides a driving current to the first light-emitting diode during the first time interval;
providing a second charging control signal, which is activated during a second time interval longer than the first time interval, to the second sub-pixel to provide the reference voltage to a gate of a second driving transistor that provides a driving current to the second light-emitting diode during the second time interval;
providing an emission control signal to each of the first sub-pixel and the second sub-pixel to charge the one end of the first light-emitting diode to a voltage at which the first driving transistor is turned off and to charge the one end of the second light-emitting diode to a voltage at which the second driving transistor is turned off, and
providing a data control signal to each of the first sub-pixel and the second sub-pixel to provide a driving current to the first light-emitting diode by the first driving transistor and to provide a driving current to the second light-emitting diode by the second driving transistor, according to data input to each of the first sub-pixel and the second sub-pixel.
